(19) United States
(12) Patent Application Publication
(10) Pub. No.: US 2015/0062366 A1
(43) Pub. Date: Mar. 5, 2015

(54) METHOD OF IMPROVING DECODING SPEED BASED ON OFF-THE-SHELF CAMERA PHONE

(71) Applicant: HONEYWELL INTERNATIONAL, INC., Morristown, NJ (US)

(72) Inventors: Yong Liu, Jiangsu (CN); Jun Lu, Jiangsu (CN)

(21) Appl. No.: 14/388,305

(22) PCT Filed: Apr. 27, 2012
(86) PCT No.: PCT/CN2012/074796

§ 371 Date: Sep. 26, 2014

(51) Int. Cl. G06K 9/18; H04N 5/232

(52) U.S. Cl. CPC G06K 9/183; H04N 5/23229
USPC 348/222.1

(57) ABSTRACT

A system and method for decoding an image of decodable indicia, the computer system that includes receiving a request to decode an image, disabling the automatic focus on a camera in a client, setting the focus to a predetermined focus point that is close to the camera lens, capturing the image, locating the decodable indicia in the image and decoding the image of decodable indicia.

### FIELD OF THE INVENTION

The present invention provides a system and method to improve the performance of a mobile device's camera, when used to decode bar codes, without making changes to the camera or mobile device hardware.

### BACKGROUND OF INVENTION

Bar codes are graphical representations of data, the most common of which are referred to as one dimensional (1D) and two dimensional (2D) bar codes. 1D bar codes are images that represents data by varying the widths and spacings of parallel lines. 2D bar codes are also images that represent data, but in addition to the parallel lines, or bars, a 2D bar code may contain rectangles, dots, hexagons and other geometric patterns in two dimensions. A common example of a 2D bar code is a Quick Response (QR) code, QR codes consist of black modules arranged in a square pattern on a white background. The data encoded in bar codes are interpreted by optical scanners and/or software.

Bar codes originally were scanned by special optical scanners called bar code readers; later, scanners and interpretive software became available on devices, including desktop printers and smart phones. Today, devices considered bar code readers include, but are not limited to: pen-type readers, laser scanners, CCD readers, camera-based readers, omni-directional bar code scanners, and cell phone cameras.

Some of the leading manufacturers of mobile devices offer bar code scanning software that can be installed on their respective devices. The goal of this software is to allow consumers to use theft mobile devices to scan bar codes that they encounter, including, but not limited to, those on products in stores or on advertisements for products and/or services located in media such as magazines and posted in public places, such as bus stops.

Rather than integrating a laser scanner into a mobile device, mobile device manufacturers rely on the camera in the device to capture the image before it is processed, i.e., decoded by the software installed on the phone or remotely accessible to the phone via a network connection.

The capability of a mobile device to decode a bar code is impeded by the speed of the process. In fact, it takes several seconds from data capture to decode out. The majority of the lag is because the camera takes too long to capture the image, slowing down the processing time in general.

When a mobile user is taking a picture with a camera phone, the photographer and the subject may have more patience and will wait for the focus, white-balance, and exposure to adjust. After all, when taking a picture with a traditional camera, individuals are accustomed to waiting to frame the perfect shot. But scanning a bar code should be faster to be of use to the mobile device owner.

Using a mobile device to decode a bar code is slow because the scheme of image capture is complex. The entirety of the decoding process includes both capturing the image of the bar code and decoding it. A standard off-the-shelf camera in a mobile device uses auto-focus, auto-white-balance and auto-exposure controls. The adjustment of these features by the mobile device accounts for the majority of the time taken by the decoding process. Because cameras in mobile devices are not optimized for capturing bar codes, the image captured after the lengthy adjustment of these features is often not useable, i.e., not enough detail was captured in the image of the bar code for the software to process the image and decode the bar code. Now, the user must repeat the lengthy process and hope the process is successful. If not, the user repeats the process and again and waits again.

A mobile device owner is less prone to scan a bar code if the activity is too time consuming. Merchants such as retailers, wholesalers, and manufacturers depend on mobile device owners scanning bar codes; retailers, wholesalers, and manufacturers link their market research as well as their promotions to data that they receive when mobile device owners scan bar codes. Thus, if mobile device owners find scanning bar codes too onerous, these retailers, wholesalers, and manufacturers miss out on market data, missing out on possible marketing opportunities and sales.

Because the time lag lies within the camera hardware itself, the most effective way to improve the speed of bar code scanning with a mobile device is by upgrading the hardware. However, cameras that are adjusted to maximize bar code scanning are not ideal for taking pictures, so the commercial viability of the camera could decrease by customizing the camera hardware to maximize bar code scanning/capture capabilities.

Additionally, a specialized hardware approach would require a consumer to purchase a mobile device that contains this hardware. Ideally, retailers, wholesalers, and manufacturers favor a solution that is not device-dependent because the more consumers scanning bar codes, the better, and every mobile device consumer will not purchase the same mobile device. The promise of “better bar code scanning” may not be the draw that directs a consumer to make a certain purchase decision.

A need therefore exists for a faster way to utilize the hardware available in the camera of an off-the-shelf mobile device to increase the speed of bar code processing.

### SUMMARY OF INVENTION

An object of the present invention is to provide a method for improving the speed of the camera in any off-the-shelf mobile device to increase the processing speed of bar code scanning with the device.

The term bar code refers to any item containing decodable indicia, including but not limited to a 1D bar code, a 2D bar code and/or one or more optical character recognition (OCR) symbols.

Unlike the large variety of pictures that a user of a camera on a mobile phone is capable of taking, images of bar codes are similar in that they will likely be taken at close range and/or under similar lighting conditions. Bar codes, although they include, but are not limited to, 1D bar codes, 2D bar codes and/or one or more optical character recognition (OCR) symbols, require a similar level of detail in order to perform decoding processing. Thus, the camera settings used when decoding a bar code or other image of decodable indicia can be decoded are similar enough that enabling the camera settings, such as auto-focus, auto-white balance, and auto-exposure and illumination, to adjust each time a bar code is to be captured, is a waste of time. Given that this time is detrimental to the success of getting mobile phone users to scan bar codes regularly, eliminating the necessity of adjusting the settings each time a picture is taken would improve the usability of the technology.

The field of view (FOV) used to capture an image of a bar code, a 50 degree diagonal, is smaller than that used by default in a camera phone, a 60 degree diagonal. The FOV of a camera refers to the portion of the world that is visible through the camera at a particular position and orientation in space. Objects outside of the FOV are not recorded. Decreasing the FOV of a camera phone decreases the amount of pixels being captured. Capturing fewer pixels saves time.

The system and method of the present invention increases the speed of bar code processing with an off-the-shelf camera phone by disabling and adjusting certain features to increase the speed and efficacy of bar code scanning with this mobile device. This method involves adjustments to the auto-focus and optionally one or more of auto-white balance, auto-exposure and illumination, and FOV.

In an embodiment of the present invention, after the adjustments are made to the auto-focus, auto-white balance, auto-exposure and illumination, and FOV, the mobile device captures an image of a bar code and sends the image to a decoder, such as a processor configured to locate and decode the decodable indicia in the image. If the decoder succeeds, the process is complete. If the decoder fails, the items are adjusted anew and another image capture is attempted. The process completes until the decoder can decode the decodable indicia in the image.

The adjustments to the auto-focus and optionally to one or more of the auto-white balance, auto-exposure and illumination, and FOV in this system and method are described below.

The present invention includes disabling the auto-focus and pre-defining focus points for the camera. In one embodiment of the present invention, the nearest focus position is selected, for example, 10 cm from the phone. The camera can toggle between this and other pre-defined position to find a suitable position, rather than adjust using the auto-focus.

Embodiments of the present invention include disabling the auto-white balance on the camera on the mobile device and setting a pre-defined white balance as the default value.

Embodiments of the present invention include controlling the auto-exposure and illumination in part by disabling the auto-exposure control. In one embodiment of the present invention, rather than use the auto-exposure control, exposure levels (gain and exposure time) are pre-defined and then, the auto-exposure selects from this limited set depending upon the focus position.

Embodiments of the present invention include includes setting an FOV of approximately 50 degrees in diagonal. This reduced FOV reduces the time of image capture. If the first image captured is unsuitable, the process is repeated to capture another frame.

In an embodiment of the present invention, the auto-white balance, auto-focus, auto-exposure and illumination, and FOV controls are centrally managed by computer-readable code that is executed on one or more processors configured to achieve this task. The one or more processors can be internal or external to the mobile device. The computer-readable code, i.e., the software is stored on a storage resource within the mobile device or external but accessible to the mobile device via a network connection.

Implementing this system and method in the software of the mobile device is advantageous because the system and method remains divorced from the hardware and is therefore useful across mobile devices. Possible implementations include, but are not limited to: 1) installing a specific bar code scanning software on the mobile device that when initialized, will manipulate the camera settings in accordance with the system and method and 2) integrating a “bar code scanning” mode into existing camera software, so when the mode is initiated, the camera settings are configured in accordance with the system and method.

Although the present invention is described in relation to manipulating the camera on a mobile device to accomplish more efficient bar code scanning, one skilled in the art will appreciate that the teachings of this invention can be applied to various types of image capture as applied to devices configured to capture images. For example, the present method can be practiced using a webcam connected to a computer system with either a wired (e.g. USB) or wireless connection.

Different bar codes are consistent enough that the process of capturing them and decoding them can be improved when the settings within a mobile camera and standardized for this image type. This same methodology, disabling automatic features and adopting default settings for a particular type of image capture to increase speed, can be adopted for groups of other similar images.

### BRIEF DESCRIPTION OF DRAWINGS

FIG. 1 is an illustration of an aspect of an embodiment the present invention.

FIG. 2 is an illustration of an aspect of an embodiment the present invention.

FIG. 3 depicts a technical architecture of an embodiment of the present invention.

FIG. 4 depicts the workflow of an embodiment of the present invention.

### DETAILED DESCRIPTION OF THE INVENTION

The present invention provides a system and method for improving the speed of the camera in any off-the-shelf mobile device to increase the processing speed of bar code scanning with the device.

Unlike when using a camera on a mobile device to take pictures, when photographing a bar code, the image quality as perceived by the human eye is less important. Rather, the ability for software running on the processor in the mobile device and/or external to the mobile device to locate and decode the decodable indicia within the image is essential. With its default settings enabled, the act of taking a picture with a camera on a mobile phone takes a few seconds. After the picture is taken, it can be sent to the decoding software. The speed of the camera impacts the usability of the mobile device because waiting a few seconds to capture a bar code is not acceptable to most users. In order to improve the speed of the device without altering the hardware, mechanisms in the camera can be disabled and adjusted. The resultant image is of lower quality, the image can be decoded and the process is much faster and therefore, attractive to the user.

The system and method of the present invention involves making adjustments to the auto-focus and optionally to one of more of the following items: 1) auto-white balance; 2) auto-exposure and illumination; and 3) FOV. These adjustments are hardware independent and therefore applicable to any mobile device camera available off-the-shelf. The adjustments to the features are implemented and controlled by software, computer-readable code, executed by one or more processors.

In general, rather than allow the features of the camera in the mobile phone to auto-adjust, the automatic capabilities are disabled and the camera is defaulted to one or more pre-defined settings. The camera toggles between only these settings until an image of sufficient quality for successful decoding is captured.

Substituting pre-defined defaults for bar code scanning is possible because there are constants when scanning a bar code. For example, the white balance can be pre-configured for black and white, the only colors in a bar code. The focus point can be pre-defined to accommodate a constant short distance because mobile device users scan bar codes from a close distance. The exposure level can be minimal because capturing a bar code does not require much illumination. Finally, the FOV can be decreased because the image quality required to decode the indicia in the bar code is less than the desired image quality when taking pictures of scenery.

Essentially, the settings are adjusted to take the lowest quality/fastest picture, but with high enough quality to decode an image of decodable indicia. Taking multiple low quality photos at default settings is faster than taking a high quality image with settings that take time to auto-adjust.

The adjustments to each feature are discussed below.

### Focus

The auto-focus mechanism is one of the slowest, if not the slowest, on a camera. Thus, the present invention includes disabling the auto-focus and pre-defining one or more default focus points for the camera. The auto-focus, when enabled, captures a few images before determining the best focus position. Limiting the number of focus positions to one or more pre-defined positions limits the amount of time the camera spends focusing.

When scanning a bar code, the user of a mobile device will generally place the bar code a short distance in front of the camera. Thus, in an embodiment of the present invention, using the shortest focus point should result in an image of sufficient quality to decode.

In an embodiment of the present invention, the nearest focus position is 10 cm from the mobile device. This is the default for an initial image capture. If this resultant image cannot be decoded by the decoder, the image capture process is repeated with the next closest focus point. The process of choosing more distant focus points is repealed until an image is captured of sufficient quality for decoding.

### White Balance

An embodiment of the present invention includes disabling the auto-white balance on the camera on the mobile device and setting a pre-defined white balance as the default value. Because current bar codes have only two colors, black and white, the functionality of the auto-white balance does not benefit the decoder and only increases the time needed for the decoding operation. By pre-defining a value, the image quality of the captured bar code is useable for decoding, while the process of capturing the image is faster.

### Exposure and Illumination

An embodiment of the present invention also includes controlling the auto-exposure and illumination in part by disabling the auto-exposure control. In one embodiment of the present invention, rather than use the auto-exposure control, exposure levels (gain and exposure time) are pre-defined and then, the auto-exposure selects from this limited set depending upon the focus position. Rather than use the auto-exposure to determine the correct illumination in a given situation, the camera toggles between one or more pre-defined levels.

In bar code scanning, brightness control need not be precise, while speed is critical. Thus, limiting the exposure to one or more pre-defined levels, will reduce the exposure time and thus reduce the time period necessary to capture an image of suitable brightness. In setting the pre-defined levels, reducing integration time is preferable to reducing flash output to improve motion tolerance. Also, in order to avoid impacting image quality, short integration and relatively large gain are selected. Taking these factors into consideration, the pre-defined levels could be set according to Table 1 or Table 2 below, for example.

TABLE 1

| Exposure Level | Exposure Time (in milliseconds) | Gain |
|---|---|---|
| level1 | 1 | 1 |
| level2 | 2 | 3 |
| level3 | 4 | 9 |

TABLE 2

| Exposure Level | Exposure Time (milliseconds) | Gain |
|---|---|---|
| level1 | 1 | 1 |
| level2 | 1 | 4 |
| level3 | 2 | 8 |
| level4 | 8 | 8 |

In an embodiment of the present invention, the fastest exposure, the setting with the lowest flash level, is selected first. If the image captured is unusable by the decoder, the second fastest setting is selected and the image captured is repeated and so on until a useable image is captured. Table 3 contains an example of a first and second setting used in an embodiment of the present invention.

TABLE 3

| Setting | Exposure Time (ms) | Gain | Flash Level |
|---|---|---|---|
| First | 1 | 1 | Lowest |
| Second | 2 | 2 | Lowest |

There is relationship between focus points and exposure and illumination, i.e., certain exposure and illumination levels are most effective dependent upon the focus point. Thus, in an embodiment of the present invention, the exposure levels are coordinated with the focus points. For example, a certain focus point will have an associated group of pre-set exposure levels. A different focus point will have a different group of associated pre-set exposure levels.

### Field of View

An embodiment of the present invention includes setting an FOV of approximately 50 degrees in diagonal. Decreasing the FOV decreases the number of pixels captured. While decreasing the amount of pixels for a standard photograph, such as a headshot, could represent a decline in quality, the image of the bar code must only have a minimum level of detail necessary for decoding. Apart from providing an image with a bar code that can be decoded, the actual picture quality, specifically the visual, is unimportant. This reduced FOV reduces the time of image capture. If the first image captured is unsuitable, the process can be repeated to capture another frame.

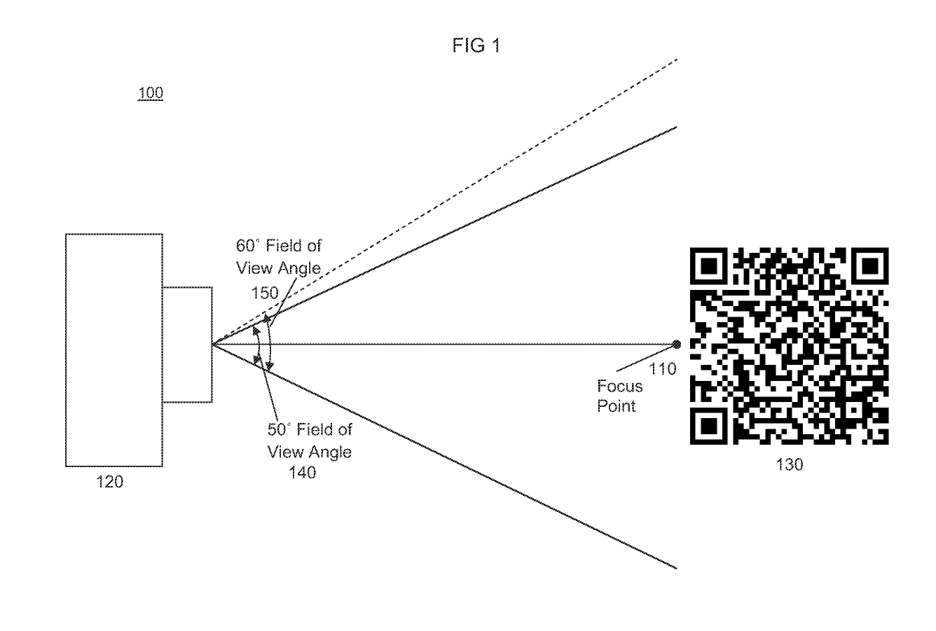

FIG. 1 is an illustration 100 of aspects of an embodiment of the present invention. Referring to FIG. 1, the focus point 110 camera 120 is a default value that is used to capture an image of the bar code 130. The FOV is set to a 50 degree diagonal 140, as opposed to the default 60 degrees diagonal 150 used to take pictures.

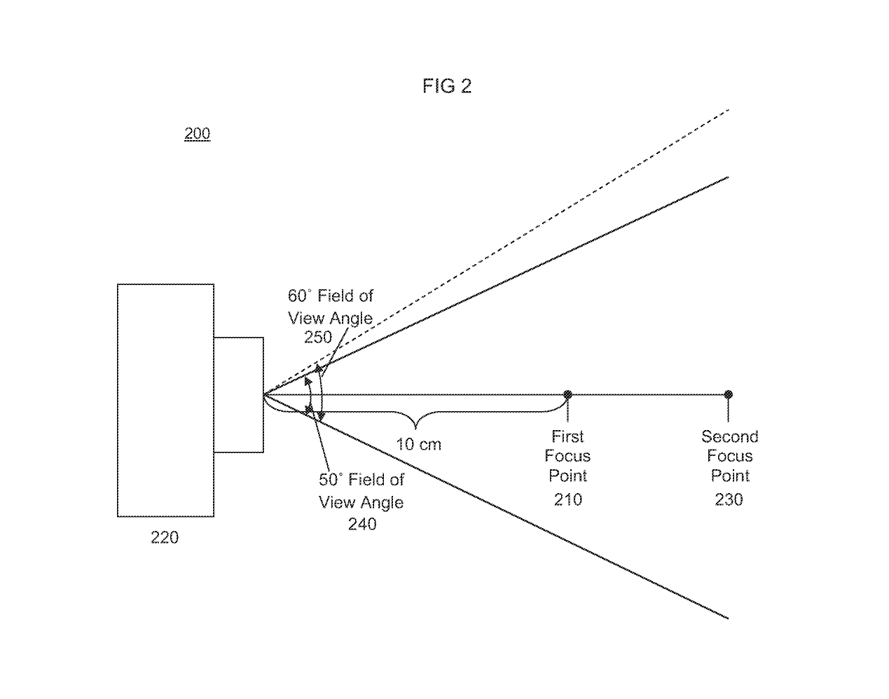

FIG. 2 is an illustration 200 of aspects of an embodiment of the present invention. The first focus point 210 of the camera 220 is 10 cm. At the default exposure level of this embodiment, if an image of decodable indicia captured using this focus point is not of sufficient quality to be decoded, the next image is captured by the camera at the second focus point 230 [Please supply a possible distance]. The FOV remains 50 degrees 240, as opposed to 60 degrees 250.

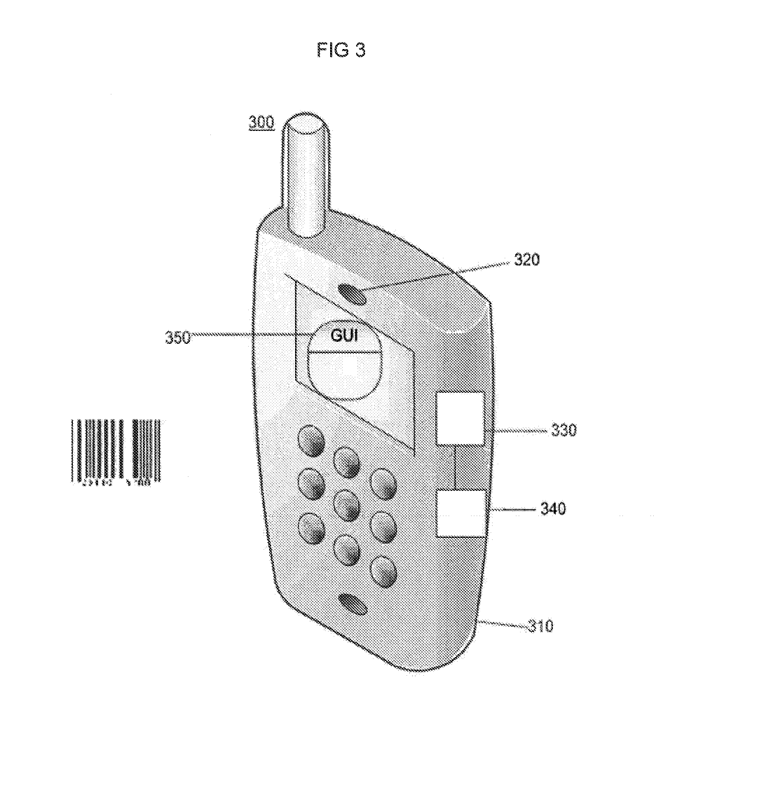

FIG. 3 depicts the technical architecture 300 of an embodiment of the present invention. In this embodiment of the present invention, the auto-white balance, auto-focus, auto-exposure and illumination, and FOV controls are centrally managed by decoding software running on a processor 330. In the embodiment of FIG. 3, the processor 330, is internal to the mobile device 310. However, additional embodiments of the present invention employ an external processor that communicates with the camera element 320 on the mobile device via a network connection.

The mobile device 310 contains a camera element 320 that is used to capture an image of a bar code, i.e., an image containing decodable indicia. Bar codes include, but are not limited to, 1D bar codes, 2D bar codes and/or one or more optical character recognition (OCR) symbols.

When the user of the mobile device indicates that he or she will be scanning a bar code, for example, by making a selection on a graphical user interface 350 on the mobile device 310, the software on the processor 330 accesses the camera element 320 in the mobile device. The decoding software disables the auto-focus and defaults the focus to a pre-determined value. Additionally, the software does one or more of the following: disables auto-white balance and defaults the white balance to a pre-determined value, disables auto-exposure routines and defaults the exposure and illumination to pre-determined values, and sets the FOV to 50 degrees in the diagonal.

In this embodiment, the software application containing the computer readable code that adjusts these settings, is implemented as part of the decoding software executed by the processor 330. Thus, when the decoding software is initialized, the camera settings are adjusted. In another embodiment of the invention, the computer-readable code is executed as part of a “bar code mode” within the general camera software of the mobile device. To initialize the application, for example, the end user could switch into “bar code mode” from “normal mode.”

After the camera element 320 has captured the image containing decodable indicia, this item, and/or a request to decode this item, is sent to a processor 330 running decoding software. The format of the image and/or request sent to the processor 330 includes, but not limited to, a raw image bitstream or a compressed byte bitstream. A compressed image bitstream includes but is not limited to a TIFF byte stream, a GIF byte stream, a JPEG byte stream, or MPEG byte stream.

Software, computer readable-code, executed on processor 330 attempts to locate the decodable indicia in the image in order to decode this image. If the software can locate and decode the image, the resultant decoded message is sent to the mobile device and/or saved on storage media 340.

The storage media of FIG. 3 is internal to the mobile device 310, but in additional embodiments of the present invention, the storage media is external to the mobile device 310 and accessible to the processor 330 via a network connection.

If the software being executed by processor 330 cannot locate and/or decode the image, in this embodiment, the processor sends a message to the camera, triggering the camera to capture another image with re-configured settings. Changes to the settings include but are not limited to, selecting the next pre-defined focus point and/or selecting the next pre-defined exposure level.

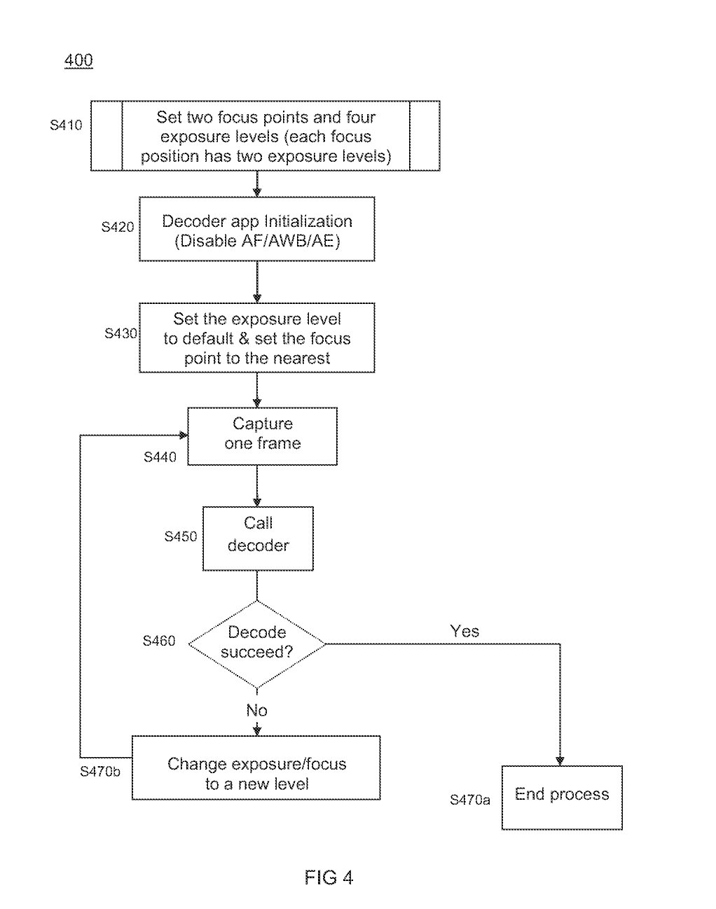

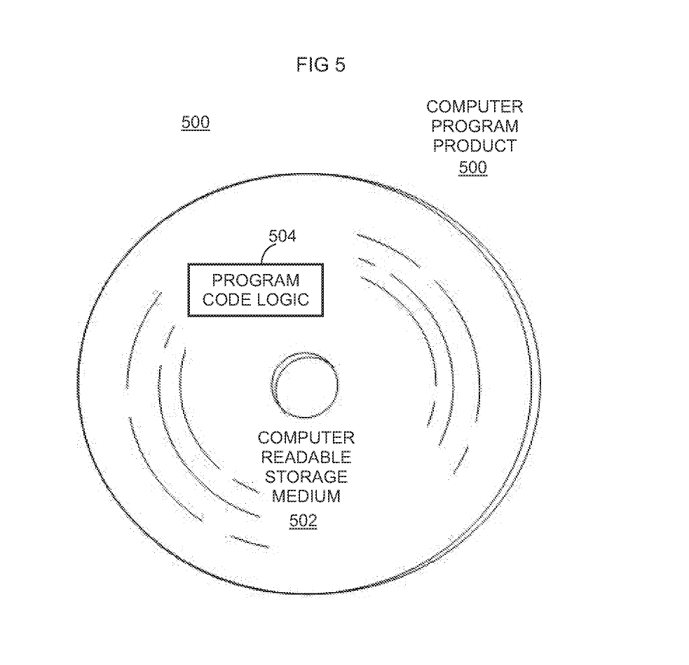

Under the control of the decoding software running on the processor, the camera element 320 captures another image and the process repeats until decoding the indicia is accomplished by the processor 330. An embodiment of this process is described in FIG. 4.

In the workflow 400 of FIG. 4, each pre-determined focus point has two associated preset exposure levels. The first focus point is closer to the mobile device than the second focus point.

In the workflow of this embodiment 400, first, two focus points and each focus point's two respective exposure levels are set by the decoder application (S410). Then, the decoder application initializes, disabling the auto-focus, auto-white balance, and auto-exposure, setting the FOV to 50 degrees, and enabling a default, pre-defined, white balance (S420). Then, the application sets the focus point closest to the camera as that which will be used for the image capture and selects a default exposure level from the two pre-defined focus points (S430). The shortest exposure is selected first, as the faster the time, the more effective the application.

Now that the settings are configured for bar code scanning, the camera mechanism captures a frame (S440). The camera makes a call to the decoder application, i.e., the image and/or request to decode the image is sent to the decoder (S450). The decoding software attempts to decode the decodable indicia in the image (S460).

If this attempt is successful, i.e., the quality of the indicia captured in the image is of sufficient quality to decode, the decoding software succeeds (S470a) and the process terminates.

In an embodiment of the present invention, the termination sequence of the application includes returning the settings of the camera in the mobile device to its defaults. For example, one or more processors would execute code to enable auto-focus, auto-white balance, auto-exposure, and re-set the FOV to 60 degrees.

If the decoding attempt fails, the decoding software reconfigures the camera by first changing the exposure to the second exposure level for the focus point and/or changing the focus point and using one of the two exposure levels at this new focus point (S470b). After making these adjustments, the camera captures another frame (S440). Again, the image is sent to the decoder for evaluation and possible decoding (S450). If the image is decoded successfully, the process terminates (S470a). If the image cannot be decoded, the settings are re-adjusted again and the process repeats, more frames are captured, until an image is produced that can be decoded.

Although the camera may ultimately take more than one frame before the decoder is successful, this process will still save time for a number of reasons, some of which are enumerated. First, the settings on the camera whose auto-adjustments require time are disabled. Second, the length of the exposure is decreased. Third, the FOV is smaller than the default for taking pictures and therefore, the camera captures fewer pixels.

The number of focus points and exposure levels in FIG. 4 is meant by way of example in this embodiment. Because the auto-controls are disabled, once the pre-set points and levels are exhausted, the camera will not attempt to capture any more frames. However, using additional settings adds time to the process. Thus, when setting the defaults for the process, one should appreciate that there is a balance between selecting multiple levels, so the process will always result in a useable frame, and attempting to capture the lowest quality, yet useable image, with the smallest set of possibilities, in order to increase the speed.

Although the present invention has been described in relation to particular embodiments thereof, many other variations and modifications will become apparent to those skilled in the art. As such, it will be readily evident to one of skill in the an based on the detailed description of the presently preferred embodiment of the system and method explained herein, that different embodiments can be realized.

Computer-readable code or instructions need not reside on processor 330. Referring to FIG. 5, in one example, a computer program product 500 includes, for instance, one or more non-transitory computer readable storage media 502 to store computer readable program code means or logic 504 thereon to provide and facilitate one or more aspects of the present invention.

Program code embodied on a computer readable medium may be transmitted using an appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language, such as Java, Smalltalk, C++ or the like, and conventional procedural programming languages, such as the “C” programming language, assembler or similar programming languages. The program code may execute entirely on processor 330 or on a remote computer systems resource accessible to processor 330 via a communications network.

One or more aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition to the above, one or more aspects of the present invention may be provided, offered, deployed, managed, serviced, etc. by a service provider who offers management of customer environments. For instance, the service provider can create, maintain, support, etc. computer code and/or a computer infrastructure that performs one or more aspects of the present invention for one or more customers. In return, the service provider may receive payment from the customer under a subscription and/or fee agreement, as examples. Additionally or alternatively, the service provider may receive payment from the sale of advertising content to one or more third parties.

In one aspect of the present invention, an application may be deployed for performing one or more aspects of the present invention. As one example, the deploying of an application comprises providing computer infrastructure operable to perform one or more aspects of the present invention.

As a further aspect of the present invention, a computing infrastructure may be deployed comprising integrating computer readable code into a computing system, in which the code in combination with the computing system is capable of performing one or more aspects of the present invention.

As yet a further aspect of the present invention, a process for integrating computing infrastructure comprising integrating computer readable code into a computer system may be provided. The computer system comprises a computer readable medium, in which the computer medium comprises one or more aspects of present invention. The code in combination with the computer system is capable of performing one or more aspects of the present invention.

Further, a data processing system suitable for storing and/or executing program code is usable that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

Input/Output or I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiment with various modifications as are suited to the particular use contemplated.

Although the present invention has been described in relation to particular embodiments thereof, many other variations and modifications will become apparent to those skilled in the art. As such, it will be readily evident to one of skill in the art based on the detailed description of the presently preferred embodiment of the system and method explained herein, that different embodiments can be realized.

1. A computer system for decoding an image of decodable indicia, the computer system comprising:
one or more processors, one or more computer-readable memories and one or more computer-readable, tangible storage devices;
program instructions, stored on at least one of the one or more storage devices for execution by at least one of the one or more processors via at least one of the one or more memories, to receive a request from a client to decode an image of decodable indicia
wherein said client is provided by a device comprising a camera and
wherein said camera comprises a lens;
program instructions, stored on at least one of the one or more storage devices for execution by at least one of the one or more processors via at least one of the one or more memories to, responsive to receiving said request, disable the automatic focus setting on said camera;
program instructions, stored on at least one of the one or more storage devices for execution by at least one of the one or more processors via at least one of the one or more memories, to, responsive to receiving said request, select a focus point from a group of predetermined focus points
wherein said focus point is the closest to said lens of said group of predetermined focus points and
wherein said focus point was not previously selected in response to said request;
program instructions, stored on at least one of the one or more storage devices for execution by at least one of the one or more processors via at least one of the one or more memories, to trigger said client to capture said image of decodable indicia at said focus point
wherein said client is configured to output said image of decodable indicia;
program instructions, stored on at least one of the one or more storage devices for execution by at least one of the one or more processors via at least one of the one or more memories, to receive said image of decodable indicia from said client;
program instructions, stored on at least one of the one or more storage devices for execution by at least one of the one or more processors via at least one of the one or more memories, to, responsive to receiving said image of decodable indicia from said client, locate said decodable indicia within said image; and
program instructions, stored on at least one of the one or more storage devices for execution by at least one of the one or more processors via at least one of the one or more memories, to, responsive to locating said decodable indicia within said image, decode said decodable indicia into a decoded message.

2. The computer system of claim 1, wherein said focus point is 10 centimeters from said lens.

3. The computer system of claim 1, further comprising:
program instructions, stored on at least one of the one or more storage devices for execution by at least one of the one or more processors via at least one of the one or more memories, to, responsive to receiving said request to decode an image of decodable indicia, perform at least one of the following actions on said client;
disable the automatic white balance on said camera and set the white balance to a predetermined balance setting,
disable the automatic exposure routines on said camera and set the exposure and illumination to a pre-determined exposure level,
set the field of view to 50 degrees in the diagonal on said camera.

4. The computer system of claim 3, wherein said predetermined exposure level comprises one of: a first level, a second level, a third level
wherein said first level comprises an exposure time of 1 millisecond and a gain of 1 and
wherein said second level comprises an exposure time of 2 milliseconds and a gain of 3 milliseconds and
wherein said third level comprises an exposure time of 4 milliseconds and a gain of 9 milliseconds.

5. The computer system of claim 3, wherein said predetermined exposure level comprises one of: a first level, a second level, a third level, a forth level
wherein said first level comprises an exposure time of 1 millisecond and a gain of 1 and
wherein said second level comprises an exposure time of 1 millisecond and a gain of 4 milliseconds and
wherein said third level comprises an exposure time of 2 milliseconds and a gain of 8 milliseconds,
wherein said fourth level comprises an exposure time of 8 milliseconds and a gain of 8 milliseconds.

6. The computer system of claim 3, wherein said predetermined balance setting is black and white.

7. The computer system of claim 3, wherein said decodable indicia is provided by at least one of: a 1D bar code, a 2D bar code, and one or more OCR symbols.

8. A method for decoding an image of decodable indicia, the method comprising the steps of:
a computer receiving a request from a client to decode an image of decodable indicia
wherein said client is provided by a device comprising a camera;
said computer, responsive to receiving said request to decode an image of decodable indicia, disabling the automatic focus setting on said camera;
said computer, responsive to receiving said request to decode an image of decodable indicia, selecting a focus point from a group of predetermined focus points
wherein said focus point selected is the closest to the lens of said camera of said group of predetermined focus points and
wherein said focus point was not previously selected in response to said request;
said computer triggering said client to capture said image of decodable indicia at said focus point
wherein said client is configured to output said image of decodable indicia;
said computer receiving said image of decodable indicia from said client;
said computer, responsive to receiving said image of decodable indicia from said client, locating said decodable indicia within said image;
said computer decoding said decodable indicia into a decoded message.

9. The method of claim 8, wherein said focus point selected is 10 centimeters from said lens.

10. The method of claim 8, further comprising:
said computer, responsive to receiving said request to decode an image of decodable indicia, performing at least one of the following actions on said client;
disabling the automatic white balance on said camera and setting the white balance to a predetermined balance setting,
disabling the automatic exposure routines on said camera and setting the exposure and illumination to a pre-determined exposure level,
setting the field of view to 50 degrees in the diagonal on said camera.

11. The method of claim 10, wherein said predetermined exposure level comprises one of: a first level, a second level, and a third level
wherein said first level comprises an exposure time of 1 millisecond and a gain of 1 and
wherein said second level comprises an exposure time of 2 milliseconds and a gain of 3 milliseconds and
wherein said third level comprises an exposure time of 4 milliseconds and a gain of 9 milliseconds.

12. The method of claim 10, wherein said predetermined exposure level comprises one of: a first level, a second level, a third level, a forth level
wherein said first level comprises an exposure time of 1 millisecond and a gain of 1 and
wherein said second level comprises an exposure time of 1 millisecond and a gain of 4 milliseconds and
wherein said third level comprises an exposure time of 2 milliseconds and a gain of 8 milliseconds,
wherein said fourth level comprises an exposure time of 8 milliseconds and a gain of 8 milliseconds.

13. The method of claim 10, wherein said predetermined balance setting is black and white.

14. The method of claim 10, wherein said decodable indicia is provided by at least one of: a 1D bar code, a 2D bar code, and one or more OCR symbols.

15. A computer program product for decoding an image of decodable indicia, the computer program product comprising:
one or more computer-readable tangible storage devices;
program instructions, stored on at least one of the one or more storage devices, to receive a request from a client to decode an image of decodable indicia
wherein said client is provided by a device comprising a camera;
program instructions, stored on at least one of the one or more storage devices to, responsive to receiving said request to decode an image of decodable indicia, disable the automatic focus setting on said camera;
program instructions, stored on at least one of the one or more storage devices to, responsive to receiving said request to decode an image of decodable indicia, select a focus point from a group of predetermined focus points
wherein said focus point selected is the closest to the lens of said camera of said group of predetermined focus points and
wherein said focus point was not previously selected in response to said request;
program instructions, stored on at least one of the one or more storage devices to trigger said client to capture said image of decodable indicia at said focus point
wherein said client is configured to output said image of decodable indicia;
program instructions, stored on at least one of the one or more storage devices, to receive said image of decodable indicia from said client;
program instructions, stored on at least one of the one or more storage devices, to, responsive to receiving said image of decodable indicia from said client, locate said decodable indicia within said image;
program instructions, stored on at least one of the one or more storage devices to, responsive to locating said decodable indicia within said image, decode said decodable indicia into a decoded message.

16. The computer program product of claim 15, wherein said focus point selected is 10 centimeters from said lens.

17. The computer program product of claim 15, further comprising:
program instructions, stored on at least one of the one or more storage devices, to, responsive to receiving said request to decode an image of decodable indicia, perform at least one of the following actions on said client;
disable the automatic white balance on said camera and set the white balance to a predetermined balance setting,
disable the automatic exposure routines on said camera and set the exposure and illumination to a pre-determined exposure level,
set the field of view to 50 degrees in the diagonal on said camera.

18. The computer program product of claim 17, wherein said predetermined exposure level comprises one of: a first level, a second level, a third level
wherein said first level comprises an exposure time of 1 millisecond and a gain of 1 and
wherein said second level comprises an exposure time of 2 milliseconds and a gain of 3 milliseconds and
wherein said third level comprises an exposure time of 4 milliseconds and a gain of 9 milliseconds.

19. The computer program product of claim 17, wherein said predetermined exposure level comprises one of: a first level, a second level, a third level, a forth level
wherein said first level comprises an exposure time of 1 millisecond and a gain of 1 and
wherein said second level comprises an exposure time of 1 millisecond and a gain of 4 milliseconds and
wherein said third level comprises an exposure time of 2 milliseconds and a gain of 8 milliseconds,
wherein said fourth level comprises an exposure time of 8 milliseconds and a gain of 8 milliseconds.

20. The computer program product of claim 17, wherein said predetermined balance setting is black and white.

21. The computer program product of claim 17, wherein said decodable indicia is provided by at least one of: a 1D bar code, a 2D bar code, and one or more OCR symbols.
